(19) United States
(12) Patent Application Publication
(10) Pub. No.: US 2004/0091584 A1
(43) Pub. Date: May 13, 2004

(54) Produce snack kit featuring condiment application that enhances the appeal of produce to children

(76) Inventor: Thomas Andrew Fink, Kettering, OH (US)

Correspondence Address: THOMAS ANDREW FINK, 1050 WEST DOROTHY LANE, APARTMENT3, KETTERING, OH, 45409, US

(21) Appl. No.: 10/292,330

(22) Filed: Nov. 12, 2002

(51) Int. Cl. A23B 4/00

(52) U.S. Cl. 426/112

(57) ABSTRACT

A produce snack kit including one or more produce pieces having an integrated guide that guides condiment application into a predetermined condiment application goal, condiment for said one or more produce pieces, and a condiment dispenser for applying the condiment to the one or more produce pieces. The invention can be embodied as methods or apparatus.

### CROSS-REFERENCE TO RELATED APPLICATIONS

The present application is related my application Ser. No. 10/280,455 filed Oct. 26, 2002, entitled “Produce Snack Kit That Enhances the Appeal of Produce to Children” currently pending. This application is incorporated herein by this reference.

### BACKGROUND

Due to the pace and demands of the modern world, parents often seek foods that are easier and more convenient to prepare for their children. In fact, many foods require no preparation at all, for example snack foods. Snack foods are especially popular with children. Health organizations have warned that many of these foods are high in fat or sugar content, or simply low in nutritional value. Habitual consumption of these foods has been associated in part with health problems such as increases in childhood obesity.

In an attempt to promote healthier diets, health organizations have recommended that parents increase the amount of fruits and vegetables eaten in their children's diets. However, despite these recommendations from health organizations, many children do not eat the amount of fruits and vegetables recommended in their daily diet. Parents often find it difficult to persuade their children to eat more fruits and vegetables. In addition, preparing many fruits and vegetables for consumption by their children can be an inconvenient process for busy parents. As opposed to fruits and vegetables in their cooked state, fruits and vegetables in their raw state are most convenient for parents and also most nutritious for children.

Therefore, a need exists for an invention that conveniently allows parents to increase the appeal of raw fruits and vegetables to their children.

### SUMMARY

The word produce is often used to refer to raw fruits and vegetables. Therefore, for the sake of brevity, the word produce may be used here forth to mean raw fruits and vegetables.

The present invention satisfies the need for an invention that conveniently allows parents to increase the appeal of raw fruits and vegetables to their children. Accordingly, the present invention has several objects and advantages including:

(a). to provide a healthy snack food for children.

(b). to provide pre-washed, pre-packaged, raw fruits and vegetables suitable for convenient consumption by children.

(c). to present raw fruits and vegetables in a manner that is appealing to children.

(d). to provide a produce piece having an integrated guide that guides condiment application into a predetermined condiment application goal.

(e). to provide visually desirable condiment application for children

(d). to improve the process of eating raw fruits and vegetables for children.

(g). to provide added functionality to raw produce to increase its appeal to children.

(h). to associate enjoyable activities to the consumption of raw produce thereby improving a child's subjective attitude concerning the consumption of raw produce.

(i). to provide increased enjoyment for children while they eat raw produce.

(j). to provide a learning experience to children while they eat raw produce.

(k). to facilitate children in the process of learning letters and associated skills requiring the use of letters.

The present invention does not require that all the objects and all the advantages need to be incorporated into every embodiment of the present invention.

A produce snack kit having features of the present invention comprises one or more produce pieces having an integrated guide that guides condiment application into a predeteimined condiment application goal, condiment for said one or more produce pieces, and means for applying the condiment to the one or more produce pieces.

The present invention teaches both apparatus and methods and thus can be embodied as apparatus or methods.

### BRIEF DESCRIPTION OF THE DRAWINGS

FIGS. 1 to 6 show various views of a produce snack kit preferred embodiment of the present invention.

FIG. 1 shows a perspective view of a produce piece.

FIG. 2 shows a sectional view of the produce piece of FIG. 1.

FIG. 3 shows a front view of a condiment dispenser ready to apply condiment to the produce piece.

FIG. 4 shows a front view of the condiment dispenser and a broken view of the produce piece of FIG. 3 after condiment has been applied.

FIG. 5 shows a perspective view of the produce piece of FIG. 4.

FIG. 6 shows a bottom view of the produce piece of FIG. 1.

FIGS. 7 to 11 show various views of another embodiment of the present invention.

FIG. 7 shows a top view of a produce piece.

FIG. 8 shows a sectional view of the produce piece of FIG. 7.

FIG. 9 shows a top view of a condiment dispenser applying condiment to the produce piece of FIG. 7.

FIG. 10 shows a plastic package of condiment with a corner torn off to provide an opening for applying condiment.

FIG. 11 shows a sectional view of the plastic package of condiment shown in FIG. 10.

### REFERENCE NUMERALS USED IN THE DRAWINGS

| | |
|---|---|
| 100 | produce piece |
| 101 | produce snack kit |
| 102 | body |
| 103 | predetermined condiment application goal |
| 104 | body surface |
| 105 | integrated guide |
| 106 | hollow |
| 108 | eye hole |
| 110 | nose hole |
| 112 | ear hole |
| 114 | mouth hole |
| 116 | mouth |
| 117 | face |
| 118 | hairhole |
| 120 | inlet aperture |
| 121 | exit apertures |
| 122 | condiment dispenser |
| 124 | nozzle |
| 126 | cap |
| 128 | condiment reservoir |
| 130 | condiment |
| 132 | condiment flow through eye hole |
| 134 | condiment flow through ear hole |
| 136 | condiment flow through nose hole |
| 138 | condiment flow through mouth hole |
| 140 | condiment flow through hair hole |
| 200 | produce piece |
| 201 | produce snack kit |
| 202 | concavity having an overall shape like the letter F |
| 203 | predetermined condiment application goal |
| 204 | package of condiment |
| 205 | torn part of package |
| 206 | condiment |
| 207 | opening in package |
| 208 | top layer of package |
| 210 | bottom layer of package |
| 212 | weld |

### DESCRIPTION

A preferred embodiment of the produce snack kit of the present invention comprises one or more produce pieces having an integrated guide that guides condiment application into a predetermined condiment application goal, condiment for said one or more produce pieces, and means for applying condiment to the one or more produce pieces. In this embodiment, the integrated guide comprises an inlet aperture, a plurality of exit apertures, and a hollow that connects the inlet aperture to the plurality of exit apertures; the predetermined application goal comprises effecting condiment to flow from said inlet aperture, through said hollow, and out said exit apertures; and the means for applying condiment comprises a condiment dispenser.

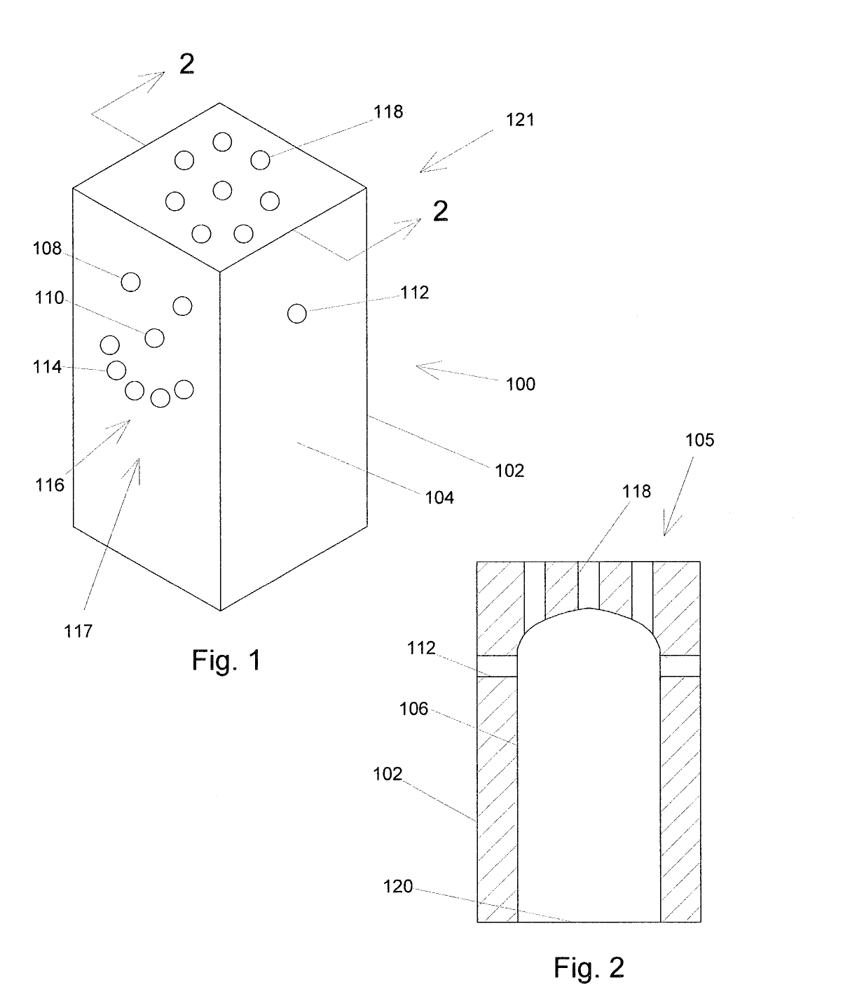

An example of this preferred produce snack kit 101 is shown in FIGS. 1 to 6. FIG. 1 shows a perspective view of a produce piece 100. FIG. 2 shows a sectional view of the produce piece. FIG. 6 shows a bottom view of the produce piece. The produce piece has a prismatic body 102 with a surface 104, and an integrated guide 105. The integrated guide comprises a hollow 106 in the body, an inlet aperture 120, and a plurality of exit apertures 121. The exit apertures comprise two eye-holes 108, a nose hole 110, two ear-holes 112, five mouth-holes 114, eight hair-holes 118. The five mouth holes create a mouth 116. The mouth holes, the nose hole, and the eye holes create a recognizable pattern of a face 117. The hollow connects the inlet aperture to the exit apertures.

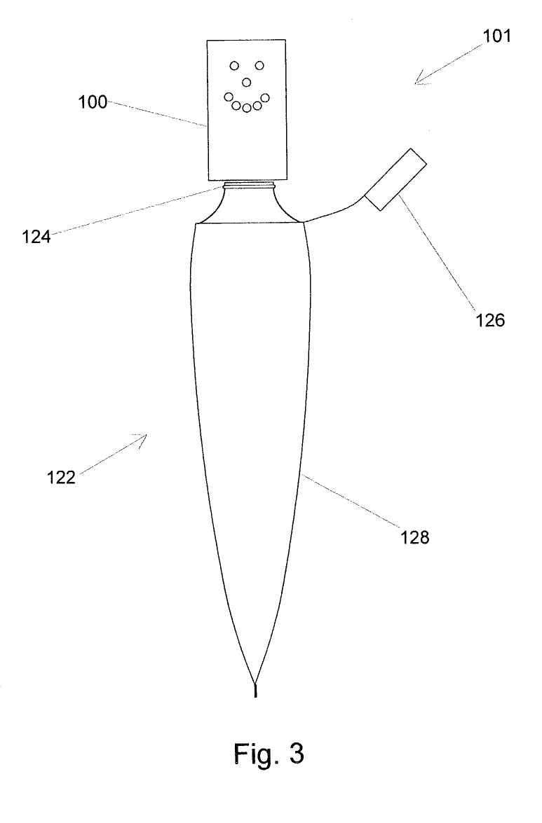

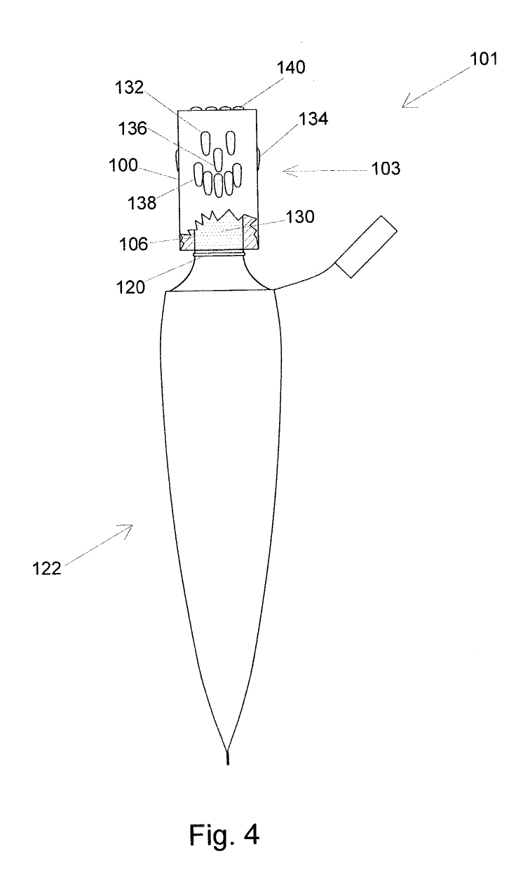

A condiment dispenser 122 is shown in FIGS. 3 and 4. The condiment dispenser comprises a condiment reservoir 128, a nozzle 124, and a cap 126. Condiment 130 is stored in the condiment reservoir. Squeezing the condiment reservoir causes condiment to flow through the nozzle. The condiment nozzle has physical characteristics commensurate with the inlet aperture to facilitate condiment application.

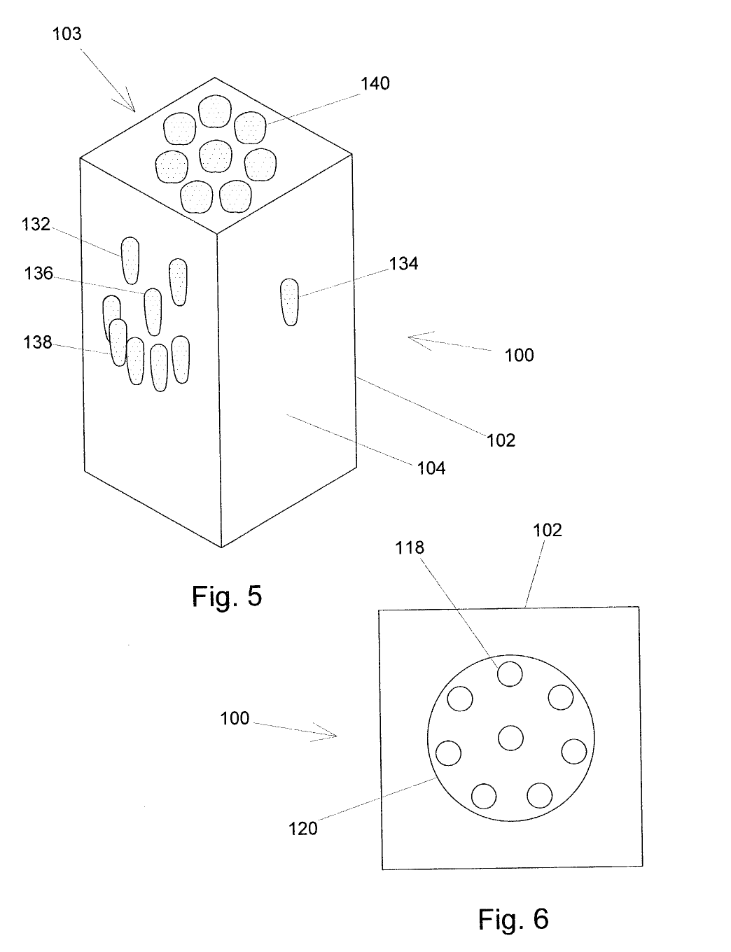

A child positions the condiment dispenser at the inlet aperture of the produce piece as shown in FIG. 3. By squeezing the condiment reservoir of the condiment dispenser, the child effects a flow of condiment from the inlet aperture, through the hollow, and out the exit apertures; thereby reaching the predetermined condiment application goal 103. FIGS. 4 and 5 show the produce piece after the condiment has been applied into the predetermined condiment application goal. The broken view of the produce piece shown in FIG. 4 shows the condiment in the hollow. After filling the hollow, condiment flows through the eye-holes 132, condiment flows through the ear holes 134, condiment flows through the nose hole, condiment flows through the mouth holes 138, and condiment flows through the hair holes 140. The child eats the produce piece as a healthy snack. Eating raw produce is recommended by many health organizations to improve children's diets.

Another embodiment of the produce snack kit of the present invention comprises one or more produce pieces having an integrated guide that guides condiment application into a predetermined condiment application goal, condiment for said one or more produce pieces, and a condiment dispenser for applying the condiment to the one or more produce pieces. In this embodiment, the integrated guide comprises a concavity having an overall shape, and the predetermined application goal comprises applying condiment into said concavity; whereby the applied condiment approximates the overall shape of the concavity.

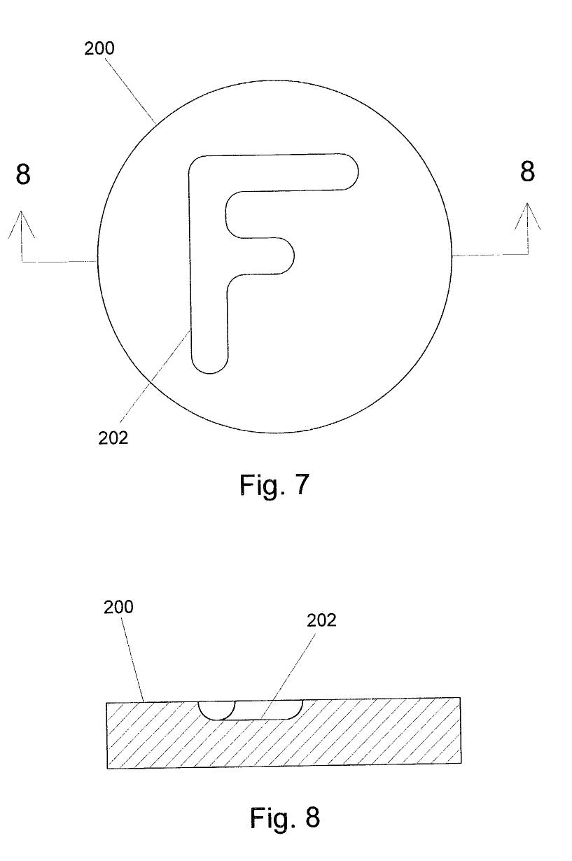

An example of this produce snack kit 201 embodiment is shown in FIGS. 7 to 11. FIG. 7 shows a disk-shaped produce piece 200 with an integrated concavity 202 that has an overall shape resembling the recognizable shape of the letter F. FIG. 8 shows a sectional view of the produce piece of FIG. 7.

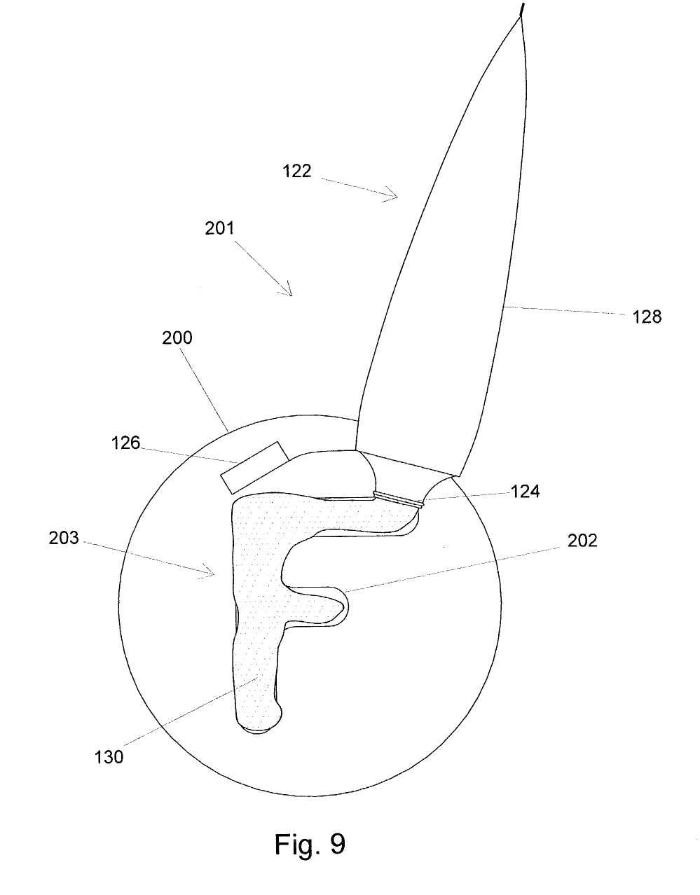

A condiment dispenser 122 is shown in FIG. 9. The condiment dispenser comprises a condiment reservoir 128, a nozzle 124, and a cap 126. Condiment 130 is stored in the condiment reservoir. Squeezing the condiment reservoir causes condiment to flow through the nozzle.

As shown in FIG. 9, a child positions the condiment dispenser over the concavity integrated into the produce piece. By squeezing the condiment reservoir of the condiment dispenser, the child applies a flow of condiment into the concavity. The child continues this application throughout the concavity. The applied condiment then approximates the overall shape of the concavity; thereby achieving the condiment application goal 203. The condiment approximates the recognizable shape of the letter F. The child eats the produce piece as a healthy snack. Eating raw produce is recommended by many health organizations to improve children's diets.

Produce pieces can be shaped using myriad shaping procedures including slicing, drilling, stamping, cutting, grinding, turning, routing, and polishing. Freshly harvested produce is cleaned and undesirable parts of the produce are trimmed. If speed and production need to be increased, shaping procedures can be mechanized. Preferred produce for the produce pieces includes carrots, apples, kohlrabi, broccoli stems, and cauliflower stems. As in the above referenced patent, the produce pieces can be offered in a disposable container, such as a plastic bag. This isolates and protects the produce pieces during shipping and handling. Thus, parents are provided pre-washed, pre-packaged, raw fruits and vegetables suitable for convenient consumption by children.

Retailers can offer a variety of condiments to meet the different tastes of children. The condiments can be sold separately from the produce pieces. This would allow children to choose the condiment they prefer with their produce pieces when forming the produce snack kit.

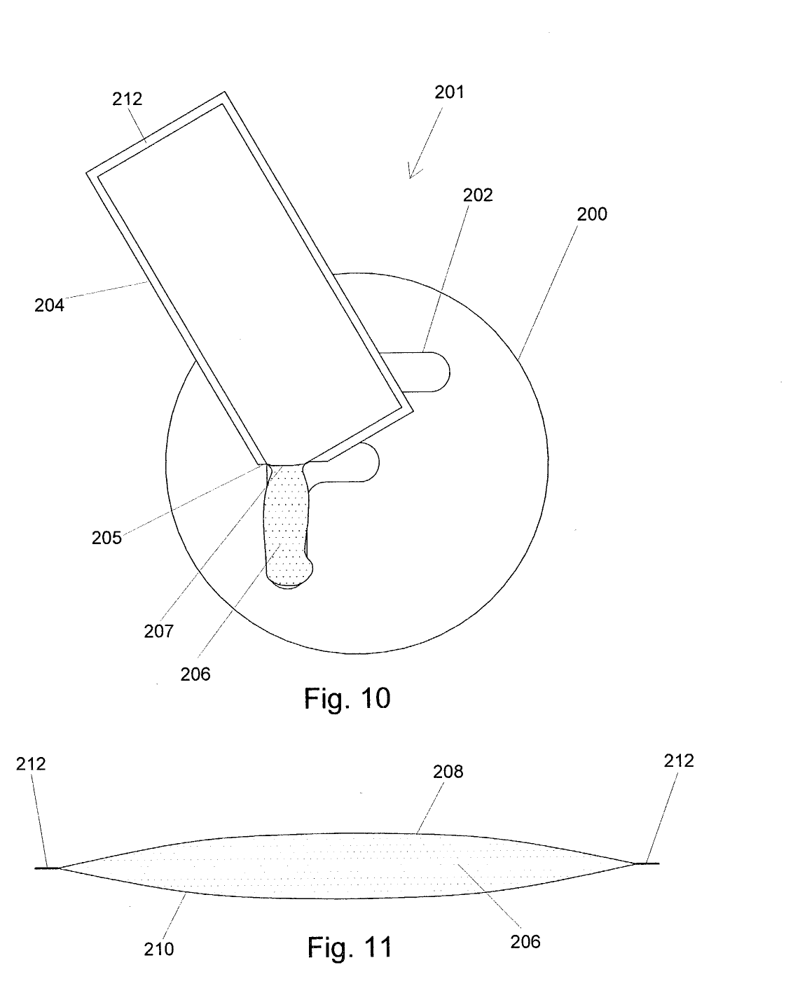

Although the description above contains many specificities, these should not be construed as limiting the scope of the invention but as merely providing illustrations of some of the presently preferred embodiments of this invention. For example, a different shaped produce piece can be used instead of the specific shapes illustrated above. A different overall shape for the concavity can be used instead of the specific shape illustrated above. A different condiment dispenser can be used. For example, FIG. 10 shows a package of condiment 204 with a corner torn off 205 to provide an opening 207 for applying condiment 206. FIG. 11 shows a sectional view of the package. As shown in FIG. 11, the package comprises a top layer 208, a bottom layer 210, and a weld 212 to adhere the top layer to the bottom layer.

The integrated guide can be any integrated feature or features of the one or more produce pieces that guide application of condiment into a predetermined condiment application goal. The condiment dispenser can be any apparatus that allows a user to apply condiment to the one or more produce pieces.

Thus the scope of the invention should be determined by the appended claims and their legal equivalents, rather than by the specific examples provided herein for illustration.

What is claimed is:

1. A method for enhancing the appeal of produce to children, the method comprising:
predetermining a condiment application goal;
integrating a guide into one or more produce pieces that guides condiment application into the predetermined condiment application goal; and
providing a produce kit comprising:
(a). the one or more produce pieces having an integrated guide that guides condiment application into the predetermined condiment application goal;
(b). condiment for the one or more produce pieces; and
(c). means for applying said condiment to the one or more produce pieces.

2. The method of claim 1 wherein the integrated guide comprises a concavity that is integrated into the one or more produce pieces, and wherein said concavity has an overall shape.

3. The method of claim 2 wherein the predetermined condiment application goal comprises applying condiment into said concavity; whereby the applied condiment approximates said overall shape of said concavity.

4. The method of claim 1 wherein said one or more produce pieces have a surface, and wherein the integrated guide comprises:
(a). an inlet aperture on said surface of said produce piece;
(b). one or more exit apertures on said surface of said produce piece; and
(c). a hollow in said produce piece that connects said inlet aperture to said one or more exit apertures.

5. The method of claim 4 wherein the predetermined condiment application goal comprises effecting said condiment to flow from said inlet aperture, through said hollow, and out said one or more exit apertures.

6. The method of claim 1 wherein said means for applying said condiment comprises:
a condiment reservoir; and
a condiment nozzle which allows said condiment to flow from said condiment reservoir to the integrated guide that is integrated in said produce piece.

7. The method of claim 1 wherein said condiment and said one or more produce pieces of the produce snack kit are offered for sale separately; whereby a retailer can offer different types of said condiment and allow said children to choose from said different types of said condiment.

8. The method of claim 1 wherein the predetermined condiment application goal comprises applying said condiment such that the applied condiment forms a recognizable shape, such as a letter of the alphabet.

9. A produce snack kit that enhances the appeal of produce to children, the produce snack kit comprising:
(a). one or more produce pieces;
(b). condiment for said one or more produce pieces;
(c). means for applying said condiment to said one or more produce pieces;
and said one or more produce pieces having
(d). an integrated guide that guides the condiment application into a predetermined condiment application goal.

10. The produce snack kit of claim 1 wherein the integrated guide comprises a concavity that is integrated into the one or more produce pieces, and wherein said concavity has an overall shape.

11. The produce snack kit of claim 2 wherein the predetermined condiment application goal comprises applying condiment into said concavity; whereby the applied condiment approximates said overall shape of said concavity.

12. The produce snack kit of claim 1 wherein said one or more produce pieces have a surface, and wherein the integrated guide comprises:
(a). an inlet aperture on said surface of said produce piece;
(b). one or more exit apertures on said surface of said produce piece; and
(c). a hollow in said body that connects said inlet aperture to said one or more exit apertures.

13. The produce snack kit of claim 4 wherein the predetermined condiment application goal comprises effecting said condiment to flow from said inlet aperture, through said hollow, and out said one or more exit apertures.

14. The produce snack kit of claim 1 wherein said means for applying said condiment comprises:
a condiment reservoir; and
a condiment nozzle which allows said condiment to flow from said condiment reservoir to the integrated guide that is integrated in said produce piece.

15. The produce snack kit of claim 1 wherein the means for applying condiment comprises a package in which an opening can be made for applying said condiment.

16. The produce snack kit of claim 1 wherein the predetermined condiment application goal comprises applying said condiment such that the applied condiment forms a recognizable shape, such as a letter of the alphabet.

17. A produce snack kit that enhances the appeal of produce to children, the produce snack kit comprising:
one or more produce pieces comprising:
(a). a body having a surface;
(b). an inlet aperture on said surface of said body;
(c). one or more exit apertures on said surface of said body; and
(d). a hollow in said body that connects said inlet aperture to said one or more exit apertures;
condiment for said one or more produce pieces; and
a condiment dispenser to effect said condiment to flow from said inlet aperture, through said hollow, and out said one or more exit apertures.

18. The produce snack kit of claim 15 wherein said exit apertures are arranged into a recognizable pattern, such as a face.

19. The produce snack kit of claim 15 wherein said condiment dispenser comprises:
a condiment reservoir; and
a condiment nozzle which allows said condiment to flow from said inlet aperture, through said hollow, and out said one or more exit apertures.

20. The produce snack kit of claim 17 wherein said condiment nozzle has physical characteristics commensurate with said inlet aperture to facilitate condiment application.
